(19) United States
(12) Patent Application Publication
(10) Pub. No.: US 2010/0062098 A1
(43) Pub. Date: Mar. 11, 2010

(54) STAMPER FOR MINUTE STRUCTURE TRANSFER AND A METHOD FOR MANUFACTURING THE SAME

(75) Inventors: Takashi Ando, Hitachi (JP); Nobuaki Kitano, Hitachi (JP); Akihiro Miyauchi, Hitachi (JP); Ryuta Washiya, Hitachi (JP); Kazumasa Ohsono, Hitachi (JP); Akihito Hongo, Tsuchiura (JP); Tsuneo Shiota, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Cable, Ltd.

(21) Appl. No.: 12/543,595

(22) Filed: Aug. 19, 2009

(30) Foreign Application Priority Data
Sep. 10, 2008 (JP) 2008-231771

(51) Int. Cl. B29C 59/02; B44C 3/02; B44C 1/22

(52) U.S. Cl. 425/385; 156/230; 216/41

(57) ABSTRACT

The present invention can provide a stamper for minute structure transfer to be excellent in durability. The present invention is characterized by which a minute pattern as formed in one side of a substrate comes in contact with a material to be transferred and the minute pattern is transferred on a resin layer of a surface of the material to be transferred. At least one layer of a thin film is mounted on at least one side of both surfaces of the substrate, the substrate and the thin film are different in a coefficient of linear expansion each other, and the substrate is curved to swell up to be convex in the side of the minute pattern by an internal stress generated in the thin film.

### TECHNICAL FIELD

The present invention relates to a stamper for minute structure transfer of a minute concave and convex configuration.

### BACKROUND ART

Semiconductor integrated circuits have been made extremely smaller in recent years. To realize an extremely small manufacturing, for example, when a pattern formation of the semiconductor integrated circuit may be micro-fabricated by photolithography, a high degree of accuracy has been required. On the other hand, as a scale of the micro-fabrication has nearly reached a wavelength of an exposing source, the formation of a pattern with a high degree of accuracy has been approaching the limit. Then, to obtain an even higher accuracy, an electron beam writing apparatus, which is a kind of charged particle beam apparatus, has been used instead of a photolithography apparatus.

However, in forming a pattern with the electron beam writing apparatus, it takes much time to expose or write a pattern with a collective exposing light method using a light source such as i-ray and ekishima laser, in a proportion of the number of patterns written by electron beams. Accordingly, more advanced the integrated degree, more longer the time for forming a pattern. Then, the throughput becomes extremely inferior.

Therefore, to speed up the pattern formation for use in an electron beam writing apparatus, the collective figure irradiating method irradiating the electron beam in a batch has been developing in combination of various kinds of configuration. However, the electron beam writing apparatus for use in the collective figure irradiating method is large-size and also required for a mechanism for accurately controlling each position of masks. Then, the apparatus becomes more expensive.

An imprinting technique transferring a surface configuration by die-press of the prescribed stamper has been known as the other pattern formation technique. The imprinting technique is designed to die-press a stamper, which has been formed concave and convex portions corresponding to a configuration of concave and convex portions of a pattern to be formed, on a material to be transferred. For example, the material to be transferred forms a resin layer on the prescribed substrate. A minute structure, in which a distance between the concave and convex portion is less than or equal to 25 nm, can be formed on the resin layer of the material to be transferred. In addition, the resin layer forming such pattern is constituted by a thin film layer formed on the substrate and a pattern layer composing of a convex portion formed on the thin film layer. The imprinting technique has been studied concerning an application to a formation of bit pattern of recording media for a large capacity and to a pattern formation of semiconductor integrated circuits. For example, a substrate for the recording media for a large capacity or a substrate for semiconductors integrated circuits can be manufactured by etching a portion of the thin film layer exposing at the concave portion of pattern formation layer, and a portion of the substrate keeping in a contact with the portion of thin film layer.

An etching accuracy of the substrate is influenced by a distribution of a thickness in a surface direction of the thin film layer. For example, in a case where the material to be transferred, in which a variation of thickness of the thin film layer amounts to 50 nm in thickness difference between a maximal thickness and a minimal thickness, is manufactured by etching at a thickness of 50 nm, the thin film layer may be etched on the substrate at a thin portion, but not etched thereon at a thick portion. Then, the thin film layer to be formed on the substrate is required to be uniform in thickness in order to maintain the prescribed accuracy of the etching. That is, when such thin film layer to be uniform in thickness is formed, the resin layer to be formed on the substrate is required to be thin and uniform in thickness in a surface direction thereof.

Conventionally, the imprinting technique forms a pattern by pressing a flat stamper on a flat material to be transferred. However, when the material to be transferred and the stamper come in contact each other, both overall surfaces come in contact completely. Accordingly, in case of the contact through the resin between the material to be transferred and the stamper, a pressure difference occurring locally in a contact face may prevents from a flow of resin, or may happen to involve air bubbles in the resin. When the flow of resin is prevented or the air bubbles are involved in the resin, a portion of the pattern formation layer becomes uneven. This tendency becomes remarkable, as the transferred area becomes large.

Accordingly, a method for transferring, which is constituted to curve a flat stamper mechanically and to come in contact between the stamper curved to be convex and the material to be transferred in order to raise a fluidized property of the resin, prevent from involving the air bubbles, and form a uniform pattern formation layer, has been known. For example, it refers to Japanese Patent Unexamined Laid-Open Publication No. 207159 of Heisei 8 (as hereinafter referred to as Patent Literature 1) and Japanese Patent Unexamined Laid-Open Publication No. 303292 of 2006 (as hereinafter referred to as Patent Literature 2). The contact area becomes gradually larger toward an outer circumference of the material to be transferred, after a convex portion of the stamper has come in a contact with a central portion of the material to be transferred in this method for transferring. As a result, the fluidized property of the resin becomes good and involving the air bubble in the pattern formation layer (resin) is prevented.

However, the above-mentioned method for transferring is mechanically curved with a tool grasping an end of the stamper. Then, the burden loaded at an end of the stamper is large in case of the grasp thereof. The stamper may be broken by a repetition of the transfer.

On the other hand, an invention for forming a surface of pattern formation of the stamper to be convex portions made of spherical elastic body has been proposed in Japanese Patent Unexamined Laid-Open Publication No. 113456 of Heisei 2 (as hereinafter referred to as Patent Literature 3). The present invention is constituted to manufacture a flat stamper made of Nickel (as referred to as Nickel stamper) to photo electroplate and exfoliate Nickel on an original resist plate. As for the flat Nickel stamper, thermal contraction sheet is made to stick to the rear surface and heat up at the prescribed temperature. The Nickel stamper is made to curve like a spherical shape. Finally, the curved Nickel stamper is obtained by removing the thermal contraction sheet. Then, in the minute structure transfer for use in the Nickel stamper, the nickel stamper is pressed to approach a surface of the flat material to be transferred, pressing from a rear surface of the curved Nickel stamper. This results in involving the air bubble locally.

### DISCLOSURE OF THE INVENTION

However, the curved amount of of the Nickel stamper in Patent Literature 3 is designated by a difference between coefficients of linear expansion of the Nickel stamper and the thermal contraction sheet. As the thermal contraction sheet includes the resin, it is not able to curve the Nickel stamper at more than or equal to glass transition temperature. That is, it has a limit to regulate the curved amount. As the Nickel stamper is curved only by an internal stress of Nickel, after the thermal contraction sheet has been removed, it has a problem to reduce the internal stress and return to be flat in the Nickel stamper, when the Nickel stamper is repeated to heat up and refrigerate in the process of minute structure transfer.

Therefore, the object of the present invention is to provide a stamper for minute structure transfer and a method for manufacturing the same, which improves the fluidized property of the resin to be better at the time of contact with the material to be transferred, and is excellent in durability by removing the burden thereto as the stamper is curved not to involve air bubbles in the pattern formation layer (resin).

The present invention for accomplishing the object is characterized in that in a stamper for minute structure transfer to transfer the minute pattern on the resin layer of the front face of the material to be transferred in order that a minute pattern formed in either one side of front and rear faces is in contact with the material to be transferred, at least one layer of thin film is provided on at least one side of the front and rear faces of the substrate, the substrate and the thin film are different in coefficient of linear expansion from the thin film, and the substrate is curved to be convex in the side of minute pattern by an internal stress generated in the thin film.

Thus, the present invention can provide a stamper for minute structure transfer and a method for manufacturing the same as being excellent in durability.

### BRIEF DESCRIPTION OF THE DRAWINGS

FIG. 1 is an explanation view of a constitution of a stamper for minute structure transfer relating to this embodiment.

FIG. 2A and FIG. 2B are process sheets explaining a method for manufacturing the stamper relating to this embodiment.

FIG. 3A, FIG. 3B, FIG. 3C and FIG. 3D are process sheets explaining a method for transferring of a minute pattern using the stamper relating to this embodiment.

FIG. 4A, FIG. 4B and FIG. 4C are process sheets explaining a method for manufacturing the stamper as the thin film formed on both faces of the substrate.

FIG. 5A, FIG. 5B, FIG. 5C and FIG. 5D are process sheets explaining a method for manufacturing the stamper as the thin film formed on both faces of the substrate.

FIG. 6 is a picture of electron microscope showing a sectional area of a resist pattern formed in Example 4.

FIG. 7 is a graph showing the wavelength characteristics of rate of reflection from a surface of pattern formation of photo plate manufactured in Example 5, a vertical axis being a rate of reflection (percentage) and a horizontal axis being a wavelength (μm) of reflected wave.

### BEST MODE FOR CARRYING OUT THE INVENTION

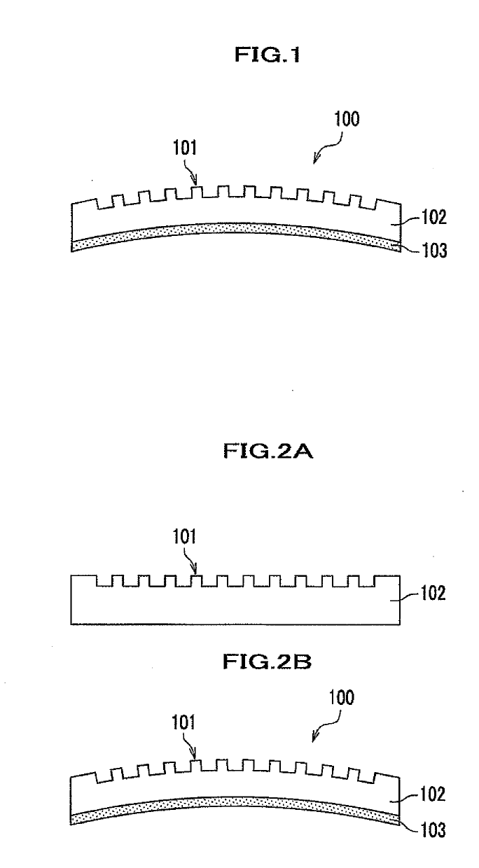

With reference to related drawings, an embodiment of a stamper for minute structure transfer relating to the present invention will be, hereinafter, explained in details. In referred drawings, FIG. 1 is a view explaining a constitution of the stamper for minute structure transfer relating to the present invention.

As shown in FIG. 1, the stamper for minute structure stamper 100 (as referred to as a stamper 100, hereinafter) is provided with a plate-shape substrate 102, and a thin film 103 formed in the substrate 102. In the stamper 100, a minute pattern 101 is formed in one side to transfer the minute pattern in a resin layer of a material to be transferred (as not shown).

As the substrate 102, it is preferable to the material to be transparent to an electromagnetic wave. Further, it is preferable to the material to be transparent more than 10 percentages to an electromagnetic wave having a wavelength between 200 nm and 2000 nm. As mentioned below, in a case where the substrate 102 is made of electromagnetic wave curing resin (photo-curing resin) as a resin layer, the resin layer can be stiffened by an irradiation of the electromagnetic wave through the substrate 102 thereon. In this electromagnetic wave, the wavelength may be, for example, an ultraviolet ray of about 365 nm, a visual light of less than or equal to a wavelength 800 nm, and a near infrared light of less than or equal to a wavelength 2000 nm.

The stamper 100 is curved for the side forming the minute pattern 101 to be convex by an internal stress generated in the thin film 103. As mentioned below, the internal stress is generated by a selection of coefficients of linear expansion different from a material of the substrate 102 as a material of the thin film 103. That is, these materials are respectively selected such that the thin film 103 becomes larger in a coefficient of linear expansion than the substrate 103.

The stamper 100 as shown in FIG. 1 is formed to be the minute pattern 101 in one side of the substrate 102. The thin film 103 is formed in the opposite side to the side forming the minute pattern 101.

The substrate 102 and the thin film 103 include at least one kind of metal element or half metal element. As examples of these elements, the material including the metal element such as Li, Mg, Al, Ti, Zn, Ga, Zr, Nb, Ta, Rb, and Sr, or the material including the half metal element such as Si, Ge, and As is given.

Further, though quartz, Si, and fluoride can be given as an example as a concrete material of the substrate 102, it is not particularly limited thereto.

Though a siliconoxide defined by a chemical formula SiOx (x is beyond 0 and less than or equal to 2) can be given as an example, it is not particularly limited thereto.

The material of the thin film 103 is defined by a chemical formula SiOx, or may be a material further including dopants such as Ge, B, and P in case of Si.

Though the thickness of the substrate 102 and the thin film 103 is not particularly limited if even, it can be appropriately designated according to a degree of curvature of the stamper 100.

For example, in the thin film 103 composing of SiO₂ as a principal component, which is 10 μm in thickness on a surface of the disk-shape substrate 102 made of quartz, when an internal stress thereof is designated as about 35 MPa, the central portion of the stamper 100 is curved to swell up by about 0.5 mm relative to the outer circumference peripheral portion. On changing a thickness of the thin film 103 from 10 μm to 20 μm, the central portion of the stamper 100 is curved to swell up by about 1 mm relative to the outer circumference peripheral portion. In a case where a thickness of the thin film 103 is designated as a constant value, a degree of curvature of the substrate 102 decreases, as the substrate 102 becomes thicker.

In a case where a thickness of the thin film 103 is larger than a wavelength of ultraviolet light, it is possible to control the influence of photo interference owing to the thin film 103. The thickness of the thin film 103 is better to be thinner than a thickness of the substrate 102 in order to decrease the burden loading the substrate 102. In concrete, a thickness of the thin film 103 is preferable to be a range between 0.5 μm and 100 μm.

Next, a method for manufacturing the stamper relating to this embodiment will be described. In the related drawings, FIG. 2A and FIG. 2B are process sheets explaining the method for manufacturing the stamper relating to this embodiment.

As shown in FIG. 2A, the method for manufacturing is herein designed for forming the minute pattern 101 by the well-known photolithography technique in one side of the flat substrate 102 made of quartz.

Next, the substrate 102 as shown in FIG. 2A is mounted inside a chamber of a control film apparatus, as not shown, to perform the next step of thin film formation.

As shown in FIG. 2B, the thin film 103 is formed in the opposite side to the side forming the minute pattern 101 of the substrate 102 in this process of thin film formation. The thin film 103 is formed by the above-mentioned film of chemical formula SiOx, and formed by the well-known spattering technique using the prescribed target. A coefficient of linear expansion of the thin film 103 composed of a film made of chemical formula SiOx is larger than a coefficient of linear expansion of quartz (substrate 102).

In this process of thin film formation, under a condition controlling the time and pressure of film formation to be the desired thickness in thickness of the thin film 103, while the thin film 103 is formed on the substrate 102, the substrate 102 and the thin film 103 are heated up at the prescribed temperature. That is, the different coefficient of linear expansion between the substrate 102 and the thin film 103, and the parallel execution of the process of thin film formation and the heating process result in an internal stress inside the thin film 103. As a result, the stamper 100, which is formed to be convex in the side forming the minute pattern 101, is manufactured.

In addition, the above-mentioned heating temperature is preferable to be designated at a higher temperature than the temperature as the stamper 100 exposed, in the process for transferring the minute pattern 101 on a surface of the material to be transferred.

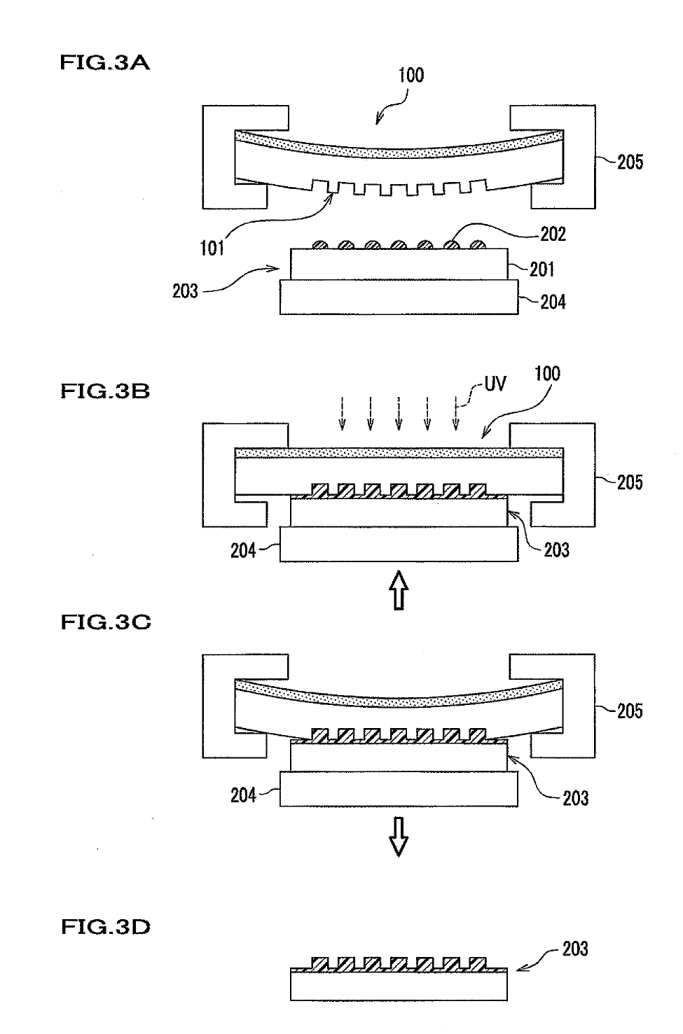

Next, a method for transferring the minute pattern using the stamper 100 relating to this embodiment, and also the function and effect of the stamper 100 will be described. The related FIG. 3A to FIG. 3D are process sheets explaining a method for transferring the minute pattern using the stamper relating to this embodiment.

In this method for transferring, the material to be transferred dropping the photo curing resin (electromagnetic wave curing resin) on a surface of the flat substrate 201 is mounted on a stage 204 actuating upwards or downwards, as shown in FIG. 3A. The stamper 100, as the minute pattern 101 formed on a surface, is retained by a mechanism for retaining the stamper.

Next, as shown in FIG. 3B, the method for transferring is designed for lifting the stage 204 by a mechanism for lifting upwards or downwards, as not shown, and pressing the material to be transferred on the stamper 100. In this case, the stamper 100 is pressed as transformed to follow a surface of the material to be transferred 203, and expanded as the photo curing resin expanded by pressing on a surface of the substrate 201 and the minute pattern 101. The photo curing resin 202 stiffens by the ultraviolet light UV irradiated from the top of the stamper 100.

Next, as shown in FIG. 3C, a stress for restoring a form of curvature is burdened by lowering the stage 204 down under a state of vacuum adsorption fixing between a rear surface of the material to be transferred and the press stage 204. As a result, the stamper 100 begins to release from a peripheral portion of the material to be transferred 203.

As shown in FIG. 3D, the material to be transferred 203, in which the minute pattern 101 of the stamper 100 is transferred on a surface of the photo curing resin 202, can be obtained by a complete release of the stamper 100 from the material to be transferred 203.

In a method for transferring for use in the stamper 100, it may be in contact in any condition as being under the ambient gaseous condition such as under the atmospheric pressure, under the reduced pressure, and nitrogen, before the stamper 100 comes in contact with a surface of the material to be transferred 203. The curved stamper 100 is different from a case where the conventional flat stamper is pressed on the material to be transferred 203 in any ambient condition. As above mentioned, as the stamper 100 is pressed, transforming to follow a surface of the material to be transferred, the fluidized property of the photo curing resin 202 can be better, and prevent from involving the air in the photo curing resin 202.

In a method for transferring for use in such stamper 100, an ambient temperature surrounding the material to be transferred and the stamper 100 changes, when the ultraviolet light UV is irradiated on the photo curing resin 202, as above mentioned. For example, the surface temperature of the pattern formation may be increased until about the temperature 80 degrees C. on receiving the irradiation of the ultraviolet light in several minutes. Then, a heating process and a refrigerating process of the stamper 100 are respectively repeated.

The stamper 100 relating to this embodiment, which is different from the conventional curved Nickel stamper (for example, as referred to the patent literature 3), is integrally constituted by the substrate 102 forming the minute pattern 101 and the thin film 103. As there is a difference between a coefficient of linear expansion of the thin film 103 and a coefficient of linear expansion of the substrate 102, an amount of curvature (degree of curvature) as restored to a room temperature even in case of a repetition of the heating process and the refrigerating process is excellent in restrorability.

As above mentioned, it is preferable that the heating temperature at the heating process as executed parallel to the process of thin film formation designate at a higher in temperature than the temperature of the transfer process. Such designation of the heating temperature at the heating process results in an excellent restrorability of the stamper 100.

As a result, the stamper 100 relating to this embodiment has a good fluidized property of the photo curing resin 202 at the time of contact with the material to be transferred 203. Further, the stamper 100 is curved to prevent from the involving air bubbles in the pattern formation layer (photo curing resin 202), and also has an excellent durability.

Though the minute pattern 101 is transferred on a surface of the photo curing resin 202 according to the above method for transferring, the stamper 100 relating to this embodiment can be used in case of transferring the minute pattern 101 on a surface of the thermoplastic resin. In this case, a resin layer made of thermoplastic resin by a spin-coating method is formed on a surface of the material to be transferred 203. Then, the resin layer is heated at more than the glass transition temperature of the thermoplastic resin then to press the stamper 100 on the resin layer. Then, the resin layer is refrigerated at less than or equal to the glass transition temperature to release the stamper 100.

The material to be transferred 203, as the minute pattern 101 transferred by such method for transferring, is applicable in magnetic recording media, data recording media such as photo recording media, parts of large-scaled integrated circuits, parts of optical parts such as a lens, a polarizing plate, a wavelength filter, a light-emitting device, and a photo integrated circuit, a bio device such as an immunity analysis, a DNA separation, and a cell culture.

Though this embodiment has been described in the above, the present invention is not limited to the above embodiment, and can be applied to various embodiments.

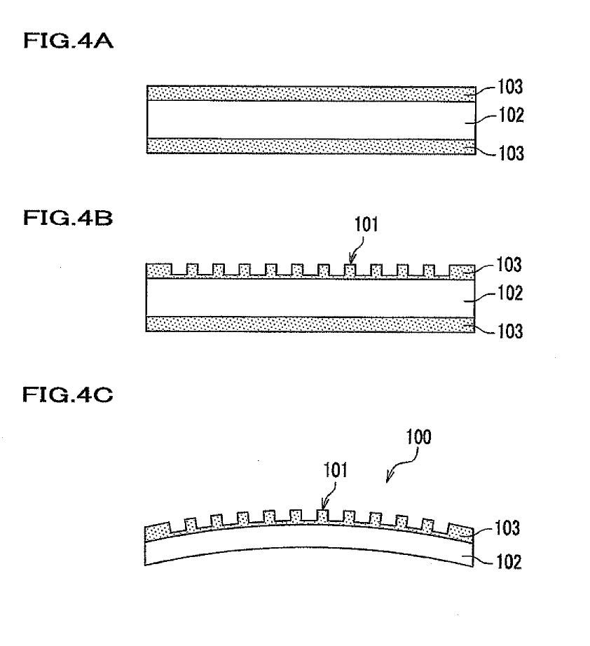

Though the stamper 100, which the thin film 103 is formed in the opposite side to the side forming the minute pattern 101, is constituted by the thin film 103 to be larger in coefficient of linear expansion than the substrate 102 in the above description, the present invention may be a stamper as the thin film 103 formed in the side forming the minute pattern 101. Herein, the stamper will be described, explaining a method for manufacturing the stamper 100. FIG. 4A to FIG. 4C, as referred to, are process sheets explaining a method for manufacturing the stamper as the thin film formed in the side forming the minute pattern of the substrate.

As shown in FIG. 4A, the thin films 103 are formed on both sides of the substrate 102 in this method for manufacturing. The thin film 103 is different from the thin film 103 (as referred to FIG. 1) in the above embodiment, and the thin film 103 is selected to be smaller in coefficient of linear expansion than the substrate 102.

Next, as shown in FIG. 4B, the minute pattern 101 is formed by the well-known photolithography on one of thin films 103. In this method for manufacturing, the stamper 100 can be obtained by removing the thin film 103 opposite to the side forming the minute pattern 101 by the well-known dry etching technique, as shown in FIG. 4C.

As the stamper 100 is constituted by that the thin film 103 is smaller in coefficient of linear expansion than the substrate 102, it is curved to be convex in the side of the thin film 103 forming the minute pattern 101 as shown in FIG. 4C.

As shown in FIG. 4A, the thin film 103 is respectively formed on both sides of the substrate 102, and as shown in FIG. 4C, the thin film 103 as the minute pattern 101 not formed is removed. Then, the minute pattern 101 can be formed on the flat thin film 103. On the other hand, in a method for forming the minute pattern 101 on the thin film 103 as formed in one side of the substrate 102, a precision of the machining may decrease owing to the minute pattern formed on the curved side.

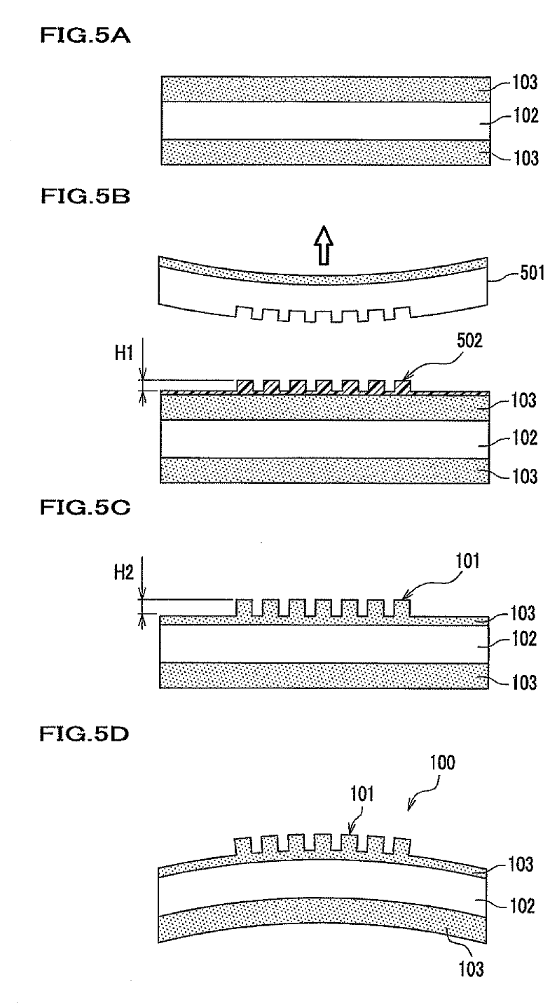

Though the stamper 100 forming the thin film 10 in the opposite side to the side forming the minute pattern 101 has been described in the above embodiment, the present invention may be a stamper forming the thin films 103 on both sides of the substrate 102. Herein, the stamper 100 will be described, explaining a method for manufacturing the stamper 100. FIG. 5A to FIG. 5D, as referred to, are process sheets explaining a method for manufacturing the stamper forming the thin film on both sides of the substrate.

As shown in FIG. 5A, the thin film 103 is formed on both sides of the substrate 102 in this method for manufacturing. This thin film 103 is selected to be larger in coefficient of linear expansion than the substrate 102, as well as the thin film (as referred to FIG. 1) in the above embodiment.

Next, as shown in FIG. 5B, the minute pattern 502 is transferred on one side of the thin film 103. The minute pattern 502 is designed to transfer the minute pattern of the stamper 501 on a resist pattern made of resin provided on the thin film 103. Though the stamper 100 relating to the above embodiment can be used as this stamper 501, the conventional stamper forming the minute pattern by the well-known electron beam writing apparatus, etc. may be used as well.

Next, as shown in FIG. 5C, the thin film 103 adjacent to the minute pattern 502 is machined by the well-known dry etching technique to use the minute pattern 502 (resist pattern) as a mask, thus to form the minute pattern 101 on the thin film 103.

In a case where the minute patterns 502 and the minute pattern 101 are constituted by a plurality of minute concave and convex portions, in concrete, by wall bodies, a plurality of recesses, etc., a height difference H1 (as referred to FIG. 5B) between a concave portion and a convex portion in the minute pattern 502 is different from a height difference H2 (as referred to FIG. 5C) between a concave portion and a convex portion in the minute pattern 101. As not shown, the angles of side walls of the concave and convex portions in the minute pattern 502 and the minute pattern 101 may be mutually different.

As a wide variety of minute patterns 101 of the stamper 100 can be made by the formation of side walls having such different heights and angles, an applicable field of minute structure as obtained by the stamper 100 can be further extended.

Next, as shown in FIG. 5D, the stamper 100 can be obtained by increasing the thickness of the thin film 103 opposite to the side forming the minute pattern 101.

The stamper 100 is constituted in order that the thin film 103 is larger in coefficient of linear expansion than the substrate 102. As shown in FIG. 5D, as the thin film 103 forming the minute pattern 101 is thicker than the opposite thin film thereto, the stamper 100 is curved to be convex in the side of the minute pattern 101.

Though the stamper 100 as shown in FIG. 4C is supposed to be curved by completely removing the thin film 103 as shown in the lower side of FIG. 4B by means of the dry etching technique, a degree of curvature by increasing or decreasing an amount to scrape off the thin film 103 can be controlled.

Though the thin film 103 forming in one side of the substrate 102 has been described concerning one layer thereof, the present invention may be constituted to form the thin film 103 to be a plurality of layers in one side of the substrate 102. Each of the thin films 103 may be made of a different material, and may have a different density in the same material.

Though the thin film 103 is supposed to be formed by one process in this embodiment, the present invention may be repeatedly formed the thin film 103 by a plurality of processes, observing the degree of curvature of the stamper 100.

Though a method for manufacturing the stamper 100 forming the thin film 103 by a spattering method has been described in the above embodiment, the present invention may be made to form the thin film 103 by a method for thin film formation such as chemical vapor deposition, vacuum vapor deposition, liquid phase epitaxy method, and spin-coating method.

Though a method for manufacturing the stamper 100 executing the heating process for heating the substrate 102 and the thin film 103 parallel to the process of thin film formation has been described in the above embodiment, the present invention may be constituted to further execute the heating process after the process of thin film formation.

Though a method for manufacturing the stamper 100 forming the minute pattern 101 by the photolithography technique has been described in the above embodiment, the present invention may be used, for example, a convergent ion beam method, an electron beam writing method, an imprinting method, etc. as the other method for formation.

### EXAMPLE

Next, the present invention will be concretely described, showing examples.

### Example 1

In this example, the stamper 100 has been manufactured by a method as shown in FIGS. 2A and 2B.

As the substrate 102, the substrate made of quartz having 100 mm in diameter, 0.5 mm in thickness, and 5.4×10⁻⁷° C.⁻¹ in coefficient of linear expansion is used. At first, as shown in FIG. 2A, the minute pattern 101 is formed by the well-known photolithography technique on one side of the substrate 102 made of quartz. The minute pattern 101 is constituted to arrange a hole having 0.5 μm in diameter and 1 μm in depth with an interval between centers thereof being 1 μm. Next, as shown in FIG. 2B, the thin film 103, of which the principal component is SiO₂, including GeO₂ of 24 mol percentage, is manufactured by the well-known spattering technique in the side opposite to the side forming the minute pattern 101.

At this time, the substrate 102 is mounted inside the chamber of a film formation apparatus as not shown, the thin film 103 is constituted to control the time for film formation in order to be 0.5 μm in thickness, heating at 200 degree C. After the substrate 102 forming the thin film 103 has been refrigerated until the room temperature, it is removed from the chamber of the film formation apparatus to obtain the stamper 100 as shown in FIG. 2B. In addition, as the thin film 103 having large coefficient of linear expansion is sufficiently contracted, it warps as shown in FIG. 2B.

On estimating the warp of the stamper 100 by a measuring apparatus of surface configuration for use in a laser, the stamper 100 is curved to swell up the central portion by about 0.5 mm relative to a direction of the surface forming the minute pattern 101, as compared with the outer circumference peripheral portion.

In addition, a transmissivity of electromagnetic wave in the stamper 100 shows 90 percentages at the transmissivity of electromagnetic wave having a wavelength of 365 nm.

### Example 2

In this example, the stamper 100 has been manufactured by a method as shown in FIG. 4A to FIG. 4C.

A multi-component glass substrate including the flat fluoride having 100 mm in diameter, 0.5 mm in thickness, and 32×10⁻⁷° C.⁻¹ in coefficient of linear expansion has been used.

As shown in FIG. 4A, the thin film 103 composing of SiO₂ having 0.5 μm by the vacuum vapor technique is formed on both sides of the substrate 102 made of quartz. The thin films 103 existing on both sides are respectively formed at a temperature 250 degree C. to keep a flat property of the substrate 102.

Next, as shown in FIG. 4B, the minute pattern 101 is formed by the well-known photolithography on one side of the substrate 102 forming the thin film 103 existing on both sides.

This minute pattern 101 is constituted to arrange a hole having 0.5 μm in diameter and 1 μm in depth with an interval between centers being 1 μm.

Next, as shown in FIG. 4C, the thin film 103, as formed in the side of the substrate 102 opposite to the minute pattern 101, is removed by the well-known dry etching technique to obtain the stamper. Then, the stamper 100 results in a warp by the refrigeration as shown in FIG. 4C.

On estimating the warp of the stamper 100 by the measuring apparatus for a surface configuration for use in a laser, the stamper 100 is curved to swell up the central portion relative to a direction of surface forming the minute pattern 101 by about 0.5 mm, as compared with an outer circumference peripheral portion.

In addition, a transmissivity of the electromagnetic wave in the stamper 100 shows 90 percentages by the transmissivity of the electromagnetic wave having the wavelength of 365 nm.

### Example 3

In this embodiment, the stamper 100 is manufactured by a method shown in FIG. 5A to FIG. 5D.

As the substrate 102, a substrate made of quartz having 100 mm in diameter, 0.5 mm in thickness, and 5.4×10⁻⁷° C.⁻¹ in coefficient of liner expansion is used.

As shown in FIG. 5A, the thin film 103, of which the principal component is SiO₂, including GeO₂ of 24 mol percentages, with the thickness thereof being 0.1 μm, is formed by the spattering technique on both sides of the substrates 102. The thin films 103 existing on both sides are respectively formed at a temperature of 200 degrees C. to keep the flat property of the substrate 102.

Next, as shown in FIG. 5B, the minute pattern 502 (resist pattern) is transferred on one side of the thin film 103 by the well-known imprinting technique. The minute pattern 502 is concentrically arranged with a line having 50 nm in width and 50 nm in height (H1 as shown in FIG. 5B) and with a line of 50 nm being at a pitch of 100 nm between the lines to form a side wall. The stamper 501 (original disc) for use in the imprinting is constituted to form the pattern corresponding to the minute pattern 502 (resist pattern) by the well-known electron beam writing technique. Then, the stamper 501 is designed to curve in the same configuration as the stamper 100 in the example 1.

Next, as shown in FIG. 5C, the minute pattern 101 is formed in the thin film 103 by machining the thin film 103 adjacent to the minute pattern 502 by the well-known dry etching technique with the minute pattern 502 (resist pattern) being used as a mask in this example.

The minute pattern 101 is designed to form a side body as arranged with the line having 50 nm in width and 80 nm in height (H2 as shown in FIG. 5C) and with the pitch between lines being 100 nm. That is, the height H2 of the minute pattern 101 is different from the height H1 of the stamper (original disc).

Next, as shown in FIG. 5D, the thin film 103, of which the principal component is SiO₂ including GeO₂ of 24 mol percentages, is further piled on the thin film 103 as formed in the opposite side to the side forming the minute pattern 101 to be 0.4 μm. As a result, the thin film 103 is constituted to form a multi layer film of 0.5 μm in total composing of two layers. The stamper 100 is refrigerated in a room temperature to warp as shown in FIG. 5D.

Though the coefficient of linear expansion of the thin film 103 is not changed, it is preferable that the exfoliations or cracks of the thin film 103 can be controlled and prevented from that the coefficient of linear expansion of the thin film 103 approaches the coefficient of linear expansion of the substrate 102, as the thin film 103 approaches the substrate 102. That is, in case of two layers of thin film 103, it is preferable that the coefficient of linear expansion of the thin film 103, of which the layer is not far from the substrate 102, but near the substrate 102, approaches the coefficient of the linear expansion of the substrate 102. In case of more than three layers of thin films 103, it is preferable that the coefficient of linear expansion of multi layers film composing of the thin film 103 approaches the coefficient of linear expansion of the substrate 102 as gradually directed from the far-positioned layer to the near-position layer.

On estimating the warp of the stamper 100, as such obtained, by the measuring apparatus of a surface configuration for use in a laser, the stamper 100 is curved to swell up the central portion by about 0.4 mm relative to a side forming the minute pattern 101 as compared with an outer circumference peripheral portion.

In addition, a transmissivity of the electromagnetic wave in the stamper 100 shows at 90 percentages of the transmissivity of the electromagnetic wave having a wavelength of 365 nm.

### Example 4

In this example, the material to be transferred 203 (minute structure body) is obtained by a method for transferring as shown in FIG. 3A to FIG. 3D. The material to be transferred 203 is manufactured by the imprinting method for use in the stamper obtained in example 3.

As shown in FIG. 3A, the material to be transferred 203 dropping the photo curing resin 202 on a surface of the flat substrate 201 made of glass is mounted on a stage 204 in this method for transferring. The substrate for the magnetic recording media, which is made of glass having 65 mm in diameter and 0.635 mm in thickness and machined a hole having 20 mm in diameter in the center thereof, is used as the flat substrate 201. The photo curing resin 202 is dropped by a dispense method on a surface of the substrate 202. The photo curing resin 202 is formulated to be 4 m Pa·s in viscosity by the addition of photo sensitive substance. 512 numbers of nozzles (256 by 2 rows) of the photo curing resin 202 are arranged and coated by a spray head emitting the photo curing resin 202 in a piezo method. A nozzle interval of the spray head is 70 μm in a row direction and 140 μm in an interval between rows. The photo curing resin 202 of about 5 pL is controlled to emit from each nozzle. A pitch of the drop of the photo curing resin 202 is designed to be 150 μm in a radial direction and 270 μm in a circumference direction. The stamper 100, as manufactured in the example 3, is designed to be pre-retained by a mechanism for retaining the stamper 205.

Next, as shown in FIG. 3B, the stage 204 is lifted by a mechanism for lifting upwards or downwards (as not shown) to press the material to be transferred 203 on the stamper 100. In this case, an end of the central hole of the substrate 201 and an inner circle portion of the stamper 100 corresponding thereto are, at first, in contact each other. Thereafter, the stage 204 is lifted and pressed until the stamper 100 is engaged with following a surface of the material to be transferred 203. The photo curing resin 202 is pressed and expanded to a surface of the substrate 201 and the minute pattern 101. The ultraviolet light is irradiated for two seconds from the top of the stamper 100 to stiffen the photo curing resin 202.

Next, as shown in FIG. 3C, the stage 204 is lowered down in a state as fixed by vaccum adsorption for a tight contact between a rear surface of the material to be transferred and a press stage 204. Then, the stamper 100 is started to be released from a part of the outside circumference of the material to be transferred by the stress to restore the stamper 100 to a curved configuration.

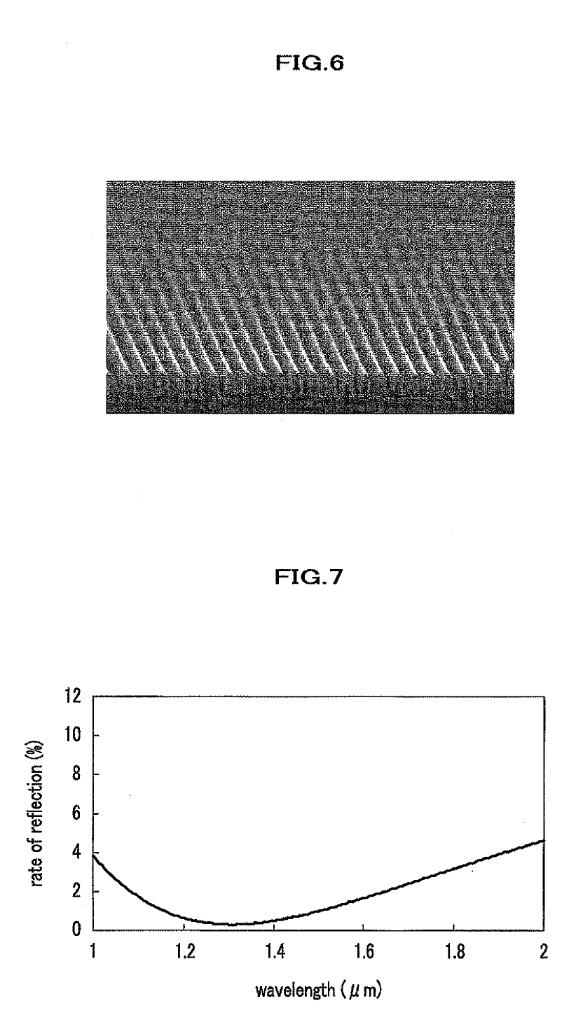

As shown in FIG. 3D, the material to be transferred 203 is obtained by transferring the minute pattern 101 of the stamper 100 on a surface of the photo curing resin 202. FIG. 6 as referred hereto is a microscopic picture showing a cross section of the resist pattern as formed in this example.

A pattern of concentrical grooves having 50 nm in width, 80 nm in depth, and 100 nm in pitch is formed on a surface of the material to be transferred 203 as a resist pattern, as shown in FIG. 6.

Next, when the dry etching technique is performed on the thin film 103 by a fluorinated gas with the resist pattern being used as a mask, a pattern of concentrical grooves having 50 nm in width, 40 nm in depth, and 100 nm in pitch is machined on a surface of the substrate 201.

In addition, a discrete track media based on a vertical magnetic recording method is manufactured, by forming a non-magnetic layer, a magnetic layer, a non-magnetic flat film, a protective film, and a lubricating film on a surface of the substrate 201.

### Example 5

In this example, a reflected light suppress device for use in the stamper 100 as manufactured by the same method as an example 1 is manufactured. In the method for transferring shown in FIG. 3A to FIG. 3D, the method for transferring for use herein is performed by the same as the method for transferring in example 4 except pressing the stamper 100 on the material to be transferred 203.

The stamper 100 is constituted to arrange a mechanism of hole having 230 nm in diameter and 400 nm in depth in an area of 30 mm by 30 mm at an interval 70 nm between neighboring two holes on a surface of the substrate 102 (as referred to FIG. 1) made of quartz having 100 mm in diameter and 0.5 mm in thickness by means of the well-known electron beam writing technique and the dry etching technique.

As the material to be transferred 203 as shown in FIG. 3A, a substrate for an optical device having 50 mm in diameter, 0.5 mm in thickness, and 2.23 in refractive index has been used.

In this method for transferring, a concave and convex pattern as formed on a surface of the material to be transferred 203 faces a concave and convex pattern of the stamper 100 each other to be constituted to arrange at an interval 70 nm of the columnar body having 230 nm in diameter and 400 nm in height.

Next, a surface of the material to be transferred 203, as the concave and convex pattern formed, is further machined by the dry etching technique. As a result, the surface of the material to be transferred 203 can be obtained a minute structure (optical plate), as not shown, to be arranged in order that the columnar body having 230 nm in diameter and 230 nm in height is at an interval of 70 nm.

Next, the reflectivity generated on a surface for pattern formation of the optical plate is measured to show the result in FIG. 7. FIG. 7, as referred hereto, is a graph showing a wavelength characteristics of the reflectivity of a surface for pattern formation of the optical plate as manufactured in this example. In FIG. 7, the refractive index (percentage) is plotted along a vertical axis and the wavelength of the refractive index (percentage) is plotted along a horizontal axis.

As shown in FIG. 7, the refractive index in the range of wavelength between the wavelength 1.16 μm and the wavelength 1.5 μm is less than or equal to 1 percentage. A substrate plate made of the same material as the material to be transferred 203 is about 14 percentages in reflectivity, except the fact that a concave and convex pattern is not formed (as not shown). According to the above result, it has been ascertained that the reflected wave can be effectively suppressed by the formation of concave and convex pattern.

What is claimed is:

1. A stamper for minute structure transfer by which a minute pattern as formed in one side of front and rear surfaces of a substrate comes in contact with a material to be transferred and the minute pattern is transferred on a resin layer of a surface of the material to be transferred,
wherein
at least one layer of a thin film is mounted on at least one side of the front and rear surfaces of the substrate,
the substrate and the thin film are different in a coefficient of linear expansion each other,
the substrate is curved to swell up to be convex in the side of the minute pattern by an internal stress generated in the thin film.

2. The stamper for minute structure transfer according to claim 1,
wherein
an electromagnetic wave having a wavelength between 200 nm and 2000 nm is designed to be transparent in a range of more than 10 percentages.

3. The stamper for minute structure transfer according to claim 1,
wherein
the resin layer on a surface of the material to be transferred comprises a resin for stiffening in case of an irradiation of the electromagnetic wave, and
the thin film is thicker in wavelength than the electromagnetic wave.

4. The stamper for minute structure transfer according to claim 3,
wherein
a thickness of the thin film ranges between 0.5 μm and 100 μm.

5. The stamper for minute structure transfer according to claim 1,
wherein
the substrate is made of quartz,
the thin film is made of an oxide film shown by SiOx having a value x ranging beyond 0 and less than or equal to 2, and
the oxide film has a density different from the quartz.

6. The stamper for minute structure transfer according to claim 1,
wherein
the substrate is made of quartz, and
the thin film is made of SiO₂ including a dopant.

7. The stamper for minute structure transfer according to claim 1,
wherein
the substrate is made of Si or a multi-component glass, and
the thin film is formed in one side forming the minute pattern of the substrate.

8. The stamper for minute structure transfer according to claim 1,
wherein
the thin film is respectively formed on one side of front and rear surfaces of the substrate, and
each of the thin film is different from at least one of a thickness and a composition each other.

9. The stamper for minute structure transfer according to claim 1,
wherein
a thickness of the thin film is constant on a surface forming the minute pattern.

10. In a method for manufacturing a stamper for minute structure transfer,
the method comprising the steps of
a thin film forming step forming at least one layer of a thin film in at least one side of front and rear sides of a substrate, and
a heating step heating the substrate and the thin film parallel to the thin film forming step or after the thin film forming step.

11. The method for manufacturing a stamper for minute structure transfer according to claim 10,
wherein a heating temperature of the heating step is higher than a temperature exposing the stamper for minute structure transfer, when a minute pattern is transferred on a surface of a material to be transferred.

12. A method for manufacturing a stamper for minute structure transfer,
wherein a resin layer forming step forming a resin layer in one side of a substrate, when the minute pattern formed as a plurality of minute concave and convex portions is formed on the substrate,
a transfer step for transferring the minute pattern of an original disc formed by coming in contact with the resin layer, and
an etching step forming the minute pattern on a surface of the substrate by an etching of the surface of the substrate for use in the resin layer forming the minute pattern as a mask,
wherein either a height of the concave and convex portions constituting the minute pattern formed by an etching on a surface of the substrate or an angle of a side wall of a projecting portion is different from a height of the concave and convex portions constituting the minute pattern of an original disc and an angle of the side wall of the concave and convex portions.
